(19) United States
(12) Patent Application Publication
(10) Pub. No.: US 2022/0241886 A1
(43) Pub. Date: Aug. 4, 2022

(54) TOOL HEAD FOR ELECTRIC HEATING TOOL

(71) Applicant: GOODHOUSE ENTERPRISE CO., LTD., Taichung City (TW)

(72) Inventor: Jung-Fa TSAI, TAICHUNG CITY (TW)

(21) Appl. No.: 17/579,891

(22) Filed: Jan. 20, 2022

(30) Foreign Application Priority Data
Jan. 29, 2021 (TW) 110103447

(51) Int. Cl. B23K 11/28

(52) U.S. Cl. CPC B23K 11/28

(57) ABSTRACT

A tool head for electric heating tool includes a body detachably set in the electric heating tool, a conductive component set mounted in the body and electrically connected to the power supply of the electric heating tool, and two heating elements set on the body. The two heating elements each contain a resistor. The two resistors are electrically connected to the conductive component set and the heating elements, so that the two heating elements generate heat, which can facilitate assembly, reduce damage, and improve technical effects such as diversified construction methods.

### BACKGROUND OF THE INVENTION

### 1. Field of the Invention

The present invention relates to electric heating tools, and particularly refers to a tool head for electric heating tool.

### 2. Description of the Related Art

When plastic components or sheet-like members are partially damaged due to external force impact such as cracks and it is difficult to repair with a bonding agent, most of them will use electric heating tools to heat the reinforcement parts into the broken portions of the plastic components for reinforcement welding.

However, the component parts of the existing electric heating tools used to heat the reinforcement parts are relatively complicated, not easy to assemble, and the construction method is relatively limited, which causes difficulties in use.

### SUMMARY OF THE INVENTION

The present invention has been accomplished under the circumstances in view. It is the main object of the present invention to provide a tool head for electric heating tool, which can facilitate assembly, reduce damage, and at the same time can improve diversified construction methods.

In order to achieve the foregoing object, the tool head for electric heating tool of the present invention is to be used with an electric heating tool that is equipped with a power supply.

The tool head comprises a body, a conductive component set, and two heating elements. The body is detachably installed in the electric heating tool. The conductive component set is set in the body and electrically connected to the power supply of the electric heating tool. The two heating elements each contain a resistor inside. The two heating elements are set in the body. The two resistors are respectively electrically connected to the conductive component set and the heating elements, thereby causing the two heating elements to generate heat, which facilitates assembly, reduces damage, and improves technical effects such as diversified construction methods.

Preferably, the body comprises a positioning portion and a joining portion. The joining portion is detachably connected to the electric heating tool. The positioning portion is set on the other end of the joining portion. The two heating elements are arranged at intervals in the positioning portion.

Preferably, the positioning portion is pivotally connected to the joining portion, and the positioning portion can rotate 360 degrees relative to the joining portion.

Preferably, the conductive component set comprises a metal base, a first conductive portion and a second conductive portion. The first conductive portion is located at one end of the metal base, the second conductive portion is located on the outer periphery of the metal base, and the second conductive portion can rotate synchronously with the metal base.

Preferably, the resistor of each heating element electrically connects each heating element to the first conductive portion and the second conductive portion.

Preferably, the resistance value of the resistor is between 0.06 ohm and 0.2 ohm.

Preferably, each heating element has a head at one end thereof, and the head has an inclined surface.

Preferably, the top of the head of each heating element penetrates a perforation.

Preferably, the inclined surface penetrates a perforation.

Preferably, the electric heating tool further comprises a reinforcing part, and the two ends of the reinforcing part are respectively inserted in the perforations of the heating elements.

The detailed structure or feature provided by the present invention will be described in the detailed description of the subsequent implementation mode. However, those skilled in the art should be able to understand that the detailed description and the specific preferred embodiment listed in the implementation of the present invention are only used to illustrate the present invention, and are not intended to limit the scope of protection of the claims of the present invention.

### BRIEF DESCRIPTION OF THE DRAWINGS

FIG. 1 is an oblique top elevational view of a tool head for electric heating tool in accordance with the present invention.

FIG. 2 is an exploded view of the tool head for electric heating tool in accordance with the present invention.

FIG. 3 is a sectional view taken along line 3-3 of FIG. 1.

FIG. 4 is a side view of the preferred embodiment of the present invention, in which the heating elements are in a sectional view.

FIG. 5 is similar to FIG. 1, and mainly shows the state of the heating elements rotating.

FIG. 6 is a cross-sectional view of the preferred embodiment of the present invention.

FIG. 7 is a schematic diagram of an implementation of the preferred embodiment of the present invention.

### DETAILED DESCRIPTION OF THE INVENTION

Hereinafter, the technical content and features of the present invention will be described in detail by enumerating a preferred embodiment in conjunction with the drawings. Those skilled in the art can understand that the present invention can be applied to various types of electric heating tools, such as electric soldering irons, welding guns, and especially electric heating tools for repairing plastic parts. The explanatory terms of the following preferred embodiment belong to a principled upper-level description that does not limit the application field, for example, the terms of material or shape include but are not limited to the material or shape specified by the description, and the terms of position include, but are not limited to, setting, approaching, connecting, or adjoining. The terms “one” and “at least one” in terms of the quantity of each component include one and more than one component quantity. The directional adjectives mentioned in the content of this specification are only exemplary descriptions based on the normal direction of use, and are not intended to limit the scope of claims.

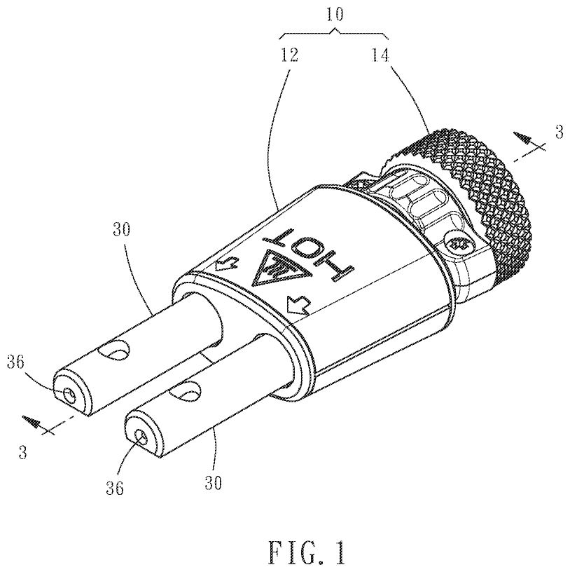

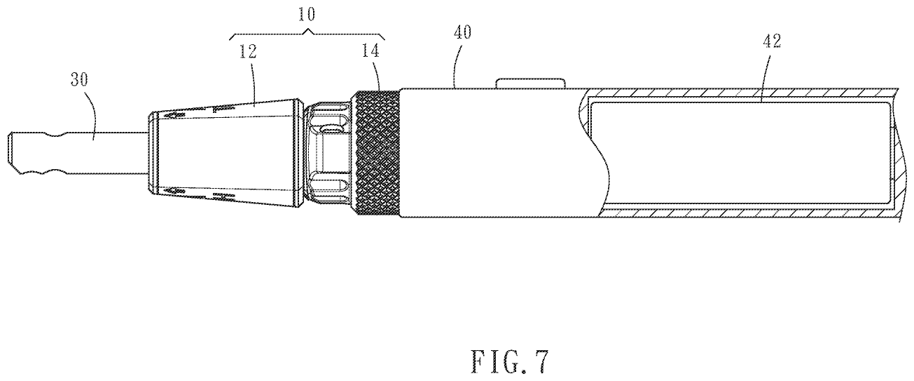

As shown in FIGS. 1 and 7, the tool head for electric heating tool provided by the preferred embodiment of the present invention is mainly a battery-type or plug-in electric heating tool for repairing plastic parts as an example. The electric heating tool 40 contains a power supply 42 inside. The power supply 42 exemplified in this preferred embodiment has a voltage of less than 6 volts. The power supply 42 can optionally contain two or more disposable batteries connected in series, and the voltage of the disposable battery is 1.5 volts. Or the power supply 42 can also be one or more secondary batteries, the voltage of the secondary battery is 3.7 volt lithium battery or nickel hydrogen battery. The tool head of the preferred embodiment of the present invention is detachably provided in the electric heating tool 40.

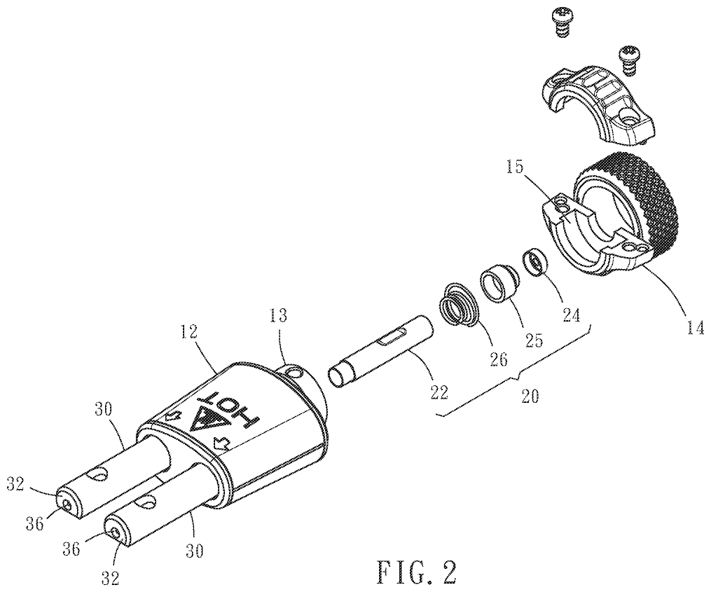

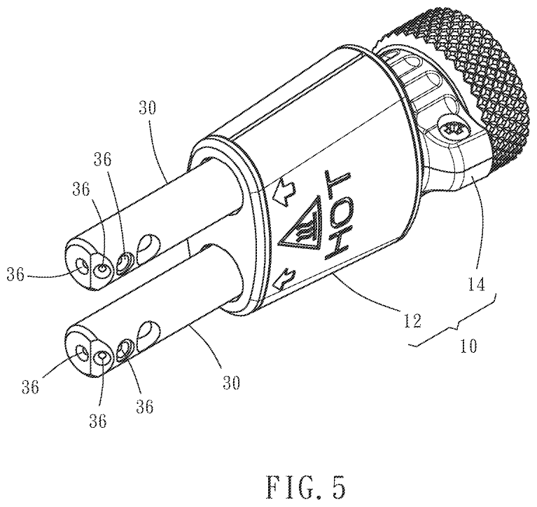

As shown in FIG. 1, FIG. 2 and FIG. 5, the tool head comprises a body 10, a conductive component set 20, and two heating elements 30. The body 10 is an example of a shell made of heat-resistant plastic. The body 10 comprises a positioning portion 12 and a joining portion 14. One end of the positioning portion 12 of the preferred embodiment has a circular protrusion 13 fitted into an annular groove 15 of the joining portion 14. The two heating elements 30 are arranged at an interval at the other end of the positioning portion 12, so that the two heating elements 30 can rotate with the positioning portion 12 relative to the joining portion 14. The joining portion 14 is detachably provided at one end of the electric heating tool 40, and the joining portion 14 of the preferred embodiment of the present invention is screwed to the electric heating tool 40 as an example.

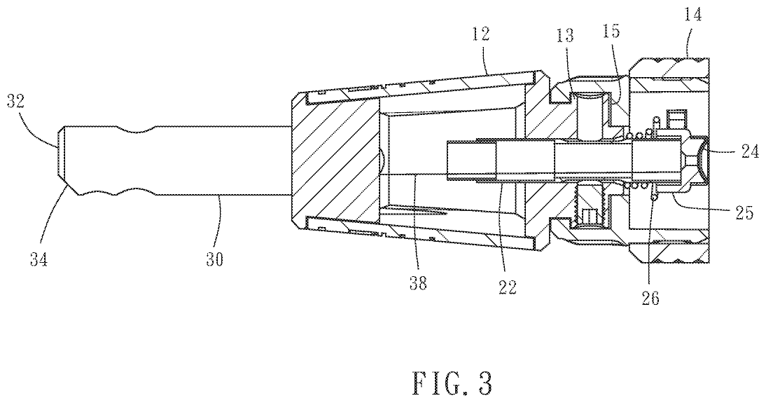

As shown in FIGS. 3 to 6, in order to realize that the two heating elements 30 can rotate with the positioning portion 12 relative to the joining portion 14, and at the same time, they are electrically connected to the power supply 42 through the conductive component set 20, the conductive component set 20 of the preferred embodiment of the present invention comprises a metal base 22, a first conductive portion 24 provided at one end of the base 22, and a second conductive portion 26 provided on the outer periphery of the base 22. The first conductive portion 24 is fixed to the metal base 22 in a manner that the first conductive portion 24 is electrically isolated from the metal base 22 by an insulating member 25. The second conductive portion 26 is provided on the metal base 22 in a manner that can rotate synchronously with the metal base 22 and is electrically connected to the metal base 22. The second conductive portion 26 of the preferred embodiment is taken as an example of extending from the metal base 22 in a coiled shape.

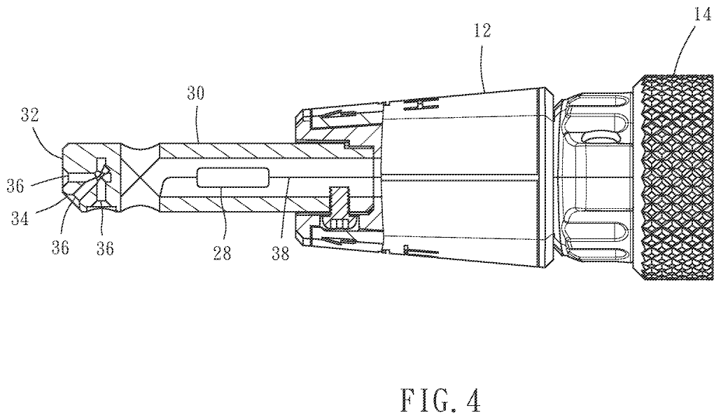

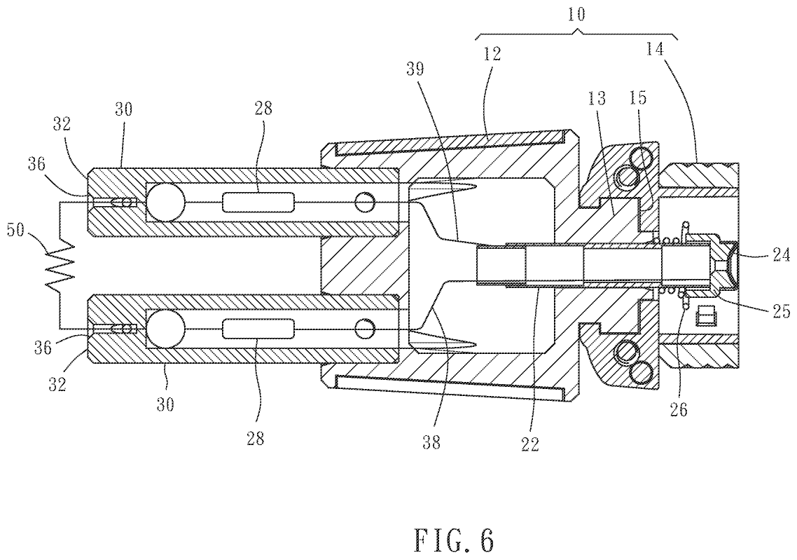

The metal base 22 passes through the center of the positioning portion 12 adjacent to the joining portion 14. Both the first conductive portion 24 and the second conductive portion 26 face the joining portion 14. When the body 10 is set on the electric heating tool 40 by the joining portion 14, the conductive component set 20 can be electrically connected to the positive and negative electrodes of the power supply 42 through the first conductive portion 24 and the second conductive portion 26, respectively. There is a resistor 28 inside each heating element 30. The resistor 28 of one heating element 30 is electrically connected in series with the first conductive portion 24 of the conductive component set 20 and the associating heating elements 30, and the resistor 28 of the other heating element 30 is electrically connected in series with the second conductive portion 26 of the conductive component set 20 and the associating heating elements 30. The resistance value of each resistor 28 is optionally between 0.06 ohm and 0.2 ohm. Specifically, as shown in FIG. 3, FIG. 4 and FIG. 6, each heating element 30 is an example of a hollow cylinder in the preferred embodiment. In the preferred embodiment, the metal base 22 is tubular as an example. The resistor 28 of one of the heating elements 30 is electrically connected to the first conductive portion 24 and the associating heating elements 30 from a wire 38 passing through the center of the metal base 22. The resistor 28 of the other heating element 30 electrically connects the second conductive portion 26 with the associating heating element 30 from a wire 39 welded to the end of the metal base 22. When the positive and negative electrodes of the power supply 42 are directly or indirectly conducted to the resistor 28 of each heating element 30 via the first conductive portion 24 and the second conductive portion 26, respectively, the two heating elements 30 generate heat energy.

Each heating element 30 has a head 32 at one end, and the head 32 has an inclined surface 34. The inclined surface 34 of the preferred embodiment is approximately 45 degrees as an example. The head 32 of the preferred embodiment is provided with at least three perforations 36, and each perforation 36 respectively penetrates the top side of the head 32 of the heating element 30, the inclined surface 34, and the outer periphery of the head 32 of the heating element 30 as examples.

Through the above-mentioned components, when the local fracture of the sheet-like plastic part is to be repaired, the user can insert the two ends of a metal reinforcing part 50 into the corresponding perforations 36 of the two heating elements 30, respectively. Perforations 36 in different positions can allow the metal reinforcing part 50 to be set at the position to be repaired at various angles. Then use the power supply 42 of the electric heating tool 40 to supply power to the resistor 28 of each heating element 30, and the heating elements 30 can generate heat to heat the reinforcing part 50. After heating, the high-temperature reinforcing part 50 can be melted and embedded in the partial fracture of the above-mentioned plastic part to complete the repair.

The positioning portion 12 of the body 10 can be rotated 360 degrees with respect to the joining portion 14. With the above-mentioned multi-angle positioning of the reinforcing part 50, the present invention can greatly improve the flexibility and change of construction, and can reduce the difficulty of repairing operations and make the use easier and more efficient.

The present invention uses the conductive component set 20 of the body 10 to be directly set on the electric heating tool 40. The single conductive component set 20 conducts the electrical energy of the power supply 42 to the heating element 30. In addition to making assembly easier and simpler, it can also improve the conductive quality of the power supply 42 and increase the efficiency of electrical energy use.

What is claimed is:

1. A tool head for electric heating tool, the electric heating tool comprising a power supply, the tool head comprising:
a body detachably installed in said electric heating tool;
a conductive component set installed in said body and electrically connected to said power supply of said electric heating tool; and
two heating elements, each said heating element comprising a resistor, said two heating elements being rotatably set on said body, said two resistors being electrically connected to said conductive component set and said heating elements, and then said power supply being electrically connected to said conductive component set at the same time, so that said two heating elements generate heat;
wherein said body comprises a positioning portion and a joining portion, said joining portion being detachably connected to said electric heating tool, [symbol] positioning portion being set at one end of said joining portion opposite to said electric heating tool, said two heating elements being arranged at intervals on said positioning portion;
wherein said positioning portion is pivotally connected to said joining portion, and said positioning portion is rotatable 360 degrees relative to said joining portion;
wherein said conductive component set comprises a metal base, a first conductive portion and a second conductive portion, said first conductive portion being located at one end of said metal base, said second conductive portion being located on the periphery of said metal base, said second conductive portion being capable of rotating synchronously with said metal base;
wherein said resistors of said heating elements electrically connect the respective said heating elements to said first conductive portion and said second conductive portion respectively;
wherein said first conductive portion is fixed to said metal base in such a way that an insulating member is electrically isolated from the metal base.

2. The tool head for electric heating tool as claimed in claim 1, wherein the resistance value of said resistors is between 0.06 ohm and 0.2 ohm.

3. The tool head for electric heating tool as claimed in claim 1, wherein each said heating element comprises a head at one end thereof, said head comprising an inclined surface.

4. The tool head for electric heating tool as claimed in claim 3, wherein said head of each said heating element has a top thereof penetrating a perforation.

5. The tool head for electric heating tool as claimed in claim 4, wherein said electric heating tool also comprises a reinforcing part, said reinforcing part having two opposite ends thereof respectively plugged in said perforations of said two heating elements.

6. The tool head for electric heating tool as claimed in claim 3, wherein said inclined surface penetrates a perforation.

7. The tool head for electric heating tool as claimed in claim 6, wherein said electric heating tool also comprises a reinforcing part, said reinforcing part having two opposite ends thereof respectively plugged in said perforations of said two heating elements.
